(19) United States
(12) Patent Application Publication
(10) Pub. No.: US 2025/0111190 A1
(43) Pub. Date: Apr. 3, 2025

(54) NEURAL NETWORK COMPUTATION METHOD AND RELATED DEVICE

(71) Applicant: Cambricon Technologies Corporation Limited, Beijing (CN)

(72) Inventors: Yuefeng LIANG, Beijing (CN); Gang SHAN, Beijing (CN); Yueran TANG, Beijing (CN); Wei GU, Beijing (CN)

(21) Appl. No.: 18/714,933

(22) PCT Filed: Nov. 10, 2022
(86) PCT No.: PCT/CN2022/131165

§ 371 Date: May 30, 2024

(30) Foreign Application Priority Data
Dec. 2, 2021 (CN) 202111471843.6

(51) Int. Cl. G06N 3/04

(52) U.S. Cl. CPC G06N 3/04

(57) ABSTRACT

The present disclosure relates to the field of artificial intelligence chips, specifically involving a neural network computation method and related devices. The computing device of the present disclosure includes a processor, a communication interface, and other processing devices. The processor and the communication interface are connected to each other through a bus to jointly complete the computations specified by a user. The computing device may also include a storage device, which is connected to the processor and other processing devices for data storage of the computing device and other processing devices. Based on an input data arrangement type and a target data arrangement type, the present disclosure performs data arrangement type conversion only on input of an operator at most, which can reduce unnecessary data arrangement type conversions during the computing process, reduce memory overhead, and improve computing efficiency.

The present disclosure is a 371 of International Application PCT/CN2022/131165, filed Nov. 10, 202, which claims priority of the Chinese Patent Application No. 202111471843.6 with the title of “NEURAL NETWORK COMPUTATION METHOD AND RELATED DEVICE” filed to the China National Intellectual Property Administration on Dec. 2, 2021. The entire contents of the Chinese patent application are incorporated into the present disclosure by reference.

### TECHNICAL FIELD

The present disclosure relates to the field of artificial neural network, and especially relates to a neural network computation method and related devices.

### BACKGROUND

In the prior art, during an operation process with a plurality of operators, data transmitted between the operators all adopt a unified data arrangement type. Therefore, when a data arrangement type of input data or output data of a certain operator is different from the unified data arrangement type, a data arrangement conversion operation is required to be performed on the input data or the output data. If there are many such operators, a large number of data arrangement conversion operations are required to be performed during the operation process. Since performing a large number of data arrangement conversion operations will generate a large number of intermediate results, there are defects such as high memory consumption and slow computing speed.

### SUMMARY

Embodiments of the present disclosure provide a neural network computation method and related devices, which are beneficial to solving the above-mentioned technical problems.

A first aspect of the embodiments of the present disclosure provides a neural network computation method, including:
obtaining a piece of first input data of a current operator and a data arrangement type of the first input data; determining a target input data arrangement type of the current operator; adjusting the first input data according to the target input data arrangement type of the current operator to obtain a piece of second input data, where a data arrangement type of the second input data is the same as the target input data arrangement type of the current operator; and computing based on the current operator and the second input data to obtain an output result, which is a piece of input data of a downstream operator of the current operator or a piece of output data of the neural network.

According to the data arrangement type of the first input data and the target data arrangement type, a data arrangement conversion operation is performed on input of the operator only when it is necessary, and the data arrangement conversion operation is no longer performed on output of the operator, so that data arrangement during network training is no longer fixed, but dynamically variable. An output result obtained by computing based on the current operator is used as the input data of the downstream operator of the current operator, which means that during a computation of an operator, a data arrangement conversion is performed at most once. Compared with performing the data arrangement conversion twice in the prior art, adopting the solution of the present disclosure may reduce unnecessary data arrangement conversion during the computation, thereby decreasing the memory overhead and improving the computation efficiency.

In a feasible embodiment, determining the target input data arrangement type of the current operator includes:
determining the target input data arrangement type of the current operator according to a data arrangement requirement of the current operator when the current operator is a data-arrangement-sensitive operator.

Further, in a feasible embodiment, adjusting the first input data according to the target input data arrangement type of the current operator to obtain the second input data includes: performing a data arrangement conversion on the first input data to obtain the second input data.

In a feasible embodiment, determining the target input data arrangement type of the current operator includes:
determining the target input data arrangement type of the current operator according to the data arrangement type of the first input data when the current operator is a data-arrangement-insensitive operator.

Further, in a feasible embodiment, adjusting the first input data according to the target input data arrangement type of the current operator to obtain the second input data includes: determining the first input data as the second input data.

When the target input data arrangement type of the current operator is determined based on the data arrangement requirement of the current operator, the data arrangement conversion is performed on the first input data to obtain the second input data. When the target input data arrangement type of the current operator is the same as the data arrangement type of the first input data, the data arrangement conversion is not performed, which means that the first input data is taken as the second input data. In this way, unnecessary data arrangement conversion during the computation is reduced, the memory overhead is decreased, and the computation efficiency is improved.

In a feasible embodiment, before performing the data arrangement conversion on the first input data to obtain the second input data, the method of the present disclosure further includes:
determining whether the data arrangement type of the first input data is the same as the target input data arrangement type of the current operator; performing the data arrangement conversion on the first input data to obtain the second input data when the data arrangement type of the first input data is different from the target input data arrangement type of the current operator; and taking the input data as the second input data when the data arrangement type of the first input data is the same as the target input data arrangement type of the current operator.

In a case where the target input data arrangement type of the current operator is determined based on the data arrangement requirement of the current operator, in order to avoid a situation where the data arrangement conversion is performed on the first input data even when the target input data arrangement type of the current operator is the same as the data arrangement type of the first input data, a judgment condition is added before performing the data arrangement conversion. The judgment condition is: when the target input data arrangement type of the current operator is the same as the data arrangement type of the first input data, the data arrangement conversion is not performed on the first input data, and the first input data is directly used for computation; only when the target input data arrangement type of the current operator is different from the data arrangement type of the first input data, the data arrangement conversion is performed on the first input data to obtain the second input data, and then the second input data is used for computation. By introducing the judgment condition, unnecessary data arrangement conversion during the computation is further avoided, the memory overhead is reduced, and the computation efficiency is improved.

In a feasible embodiment, the first input data includes a plurality of pieces of input data, and the data arrangement type of the first input data includes a plurality of data arrangement types corresponding to the plurality of pieces of input data.

When the current operator is a data-arrangement-insensitive operator, determining the target input data arrangement type of the current operator includes:
arbitrarily selecting one of the data arrangement types corresponding to the plurality of pieces of input data as the target input data arrangement type of the current operator;
or
determining the target input data arrangement type of the current operator according to the plurality of data arrangement types corresponding to the plurality of pieces of input data and a plurality of memories occupied by the plurality of pieces of input data.

In the two methods described above, the former has a simple logic, while the latter has a low memory overhead.

In a feasible embodiment, determining the target input data arrangement type of the current operator according to the plurality of data arrangement types corresponding to the plurality of pieces of input data and the plurality of memories occupied by the plurality of pieces of input data includes:
accumulating memories occupied by input data with the same data arrangement type among the plurality of pieces of input data respectively; and determining a data arrangement type corresponding to a maximum memory accumulation result as the target input data arrangement type of the current operator.

For a case of multiple inputs or multiple outputs, the method of the present disclosure is also applicable, which may reduce the unnecessary data arrangement conversion during the computation, reduce the memory overhead, and improve the computation efficiency.

In a feasible embodiment, the data-arrangement-sensitive operator includes at least one of following operators:
an operator that has an explicit requirement on a data arrangement type of input data;
an operator that has no explicit requirement on the data arrangement type of the input data, but the input data contains a mask, an index, and a tensor related to an arrangement order; and
an operator whose input data dimension is different from an output dimension, or an operator that depends on an adjacent relationship of dimensions.

In a feasible embodiment, the data-arrangement-insensitive operator includes at least one of following operators:
an operator with the same computation logic for all input elements; and
an operator that operates on a specified dimension and has no dependency on the adjacent relationship of the dimensions, or an addition operator, a subtraction operator, a multiplication operator, or a division operator.

A second aspect of the embodiments of the present disclosure provides a neural network computing device, including:
an obtaining unit configured to obtain a piece of first input data of a current operator and a data arrangement type of the first input data;
a determining unit configured to determine a target input data arrangement type of the current operator;
an adjusting unit configured to adjust the first input data according to the target input data arrangement type of the current operator to obtain a piece of second input data, where a data arrangement type of the second input data is the same as the target input data arrangement type of the current operator; and
a computing unit configured to compute based on the current operator and the second input data to obtain an output result, which is a piece of input data of a downstream operator of the current operator or a piece of output data of the neural network.

In a feasible embodiment, the determining unit is specifically configured to, when the current operator is a data-arrangement-sensitive operator, determine the target input data arrangement type of the current operator according to data arrangement requirement of the current operator.

Further, in a feasible embodiment, the adjusting unit is specifically configured to perform a data arrangement conversion on the first input data to obtain the second input data.

In a feasible embodiment, the determining unit is specifically configured to, when the current operator is a data-arrangement-insensitive operator, determine the target input data arrangement type of the current operator according to the data arrangement type of the first input data.

Further, in a feasible embodiment, the adjusting unit is specifically configured to determine the first input data as the second input data.

In a feasible embodiment, the determining unit is further configured to:
determine, before performing the data arrangement conversion on the first input data to obtain the second input data, whether the data arrangement type of the first input data is the same as the target input data arrangement type of the current operator; perform the data arrangement conversion on the first input data to obtain the second input data when the data arrangement type of the first input data is different from the target input data arrangement type of the current operator; and take the input data as the second input data when the data arrangement type of the first input data is the same as the target input data arrangement type of the current operator.

In a feasible embodiment, the first input data includes a plurality of pieces of input data, and the data arrangement type of the first input data includes a plurality of data arrangement types corresponding to the plurality of pieces of input data. When the current operator is a data-arrangement-insensitive operator, the determining unit is specifically configured to:
arbitrarily select one of the data arrangement types corresponding to the plurality of pieces of input data as the target input data arrangement type of the current operator;
or
determine the target input data arrangement type of the current operator according to the plurality of data arrangement types corresponding to the plurality of pieces of input data and a plurality of memories occupied by the plurality of pieces of input data.

In a feasible embodiment, in terms of determining the target input data arrangement type of the current operator according to the plurality of data arrangement types corresponding to the plurality of pieces of input data and a plurality of memories occupied by the plurality of pieces of input data, the determining unit is specifically configured to:
accumulate memories occupied by input data with the same data arrangement type among the plurality of pieces of input data respectively; and determine a data arrangement type corresponding to a maximum memory accumulation result as the target input data arrangement type of the current operator.

In a feasible embodiment, the data-arrangement-sensitive operator includes at least one of following operators:
an operator that has an explicit requirement on a data arrangement type of input data;
an operator that has no explicit requirement on the data arrangement type of the input data, but the input data contains a mask, an index, and a tensor related to arrangement of the input data; and
an operator whose input data dimension is different from an output dimension, or an operator that depends on an adjacent relationship of dimensions.

In a feasible embodiment, the data-arrangement-insensitive operator includes at least one of following operators:
an operator with the same computation logic for all input elements;
an operator that operates on a specified dimension and has no dependency on the adjacent relationship of the dimensions, or an addition operator, a subtraction operator, a multiplication operator, or a division operator.

A third aspect of the embodiments of the present disclosure provides an electronic device, including a processor and a memory, where the processor and the memory are connected. The memory is used to store program codes, and the processor is used to call the program codes to execute part or all of the method of the first aspect.

A fourth aspect of the embodiments of the present disclosure provides an artificial intelligence chip, which is applied to the electronic device. The artificial intelligence chip includes one or more interface circuits and one or more processors. The interface circuit(s) and the processor(s) are interconnected by lines. The interface circuit(s) is used to receive signals from a memory of the electronic device and send signals to the processor(s). The signals include computer instructions stored in the memory. When the processor executes the computer instructions, the electronic device executes part or all of the method described in the first aspect.

A fifth aspect of the embodiments of the present disclosure provides a computer readable storage medium, in which a computer program is stored, and the computer program is executed by a processor to implement part or all of the method described in the first aspect.

A sixth aspect of the embodiments of the present disclosure provides a computer program product, which includes computer instructions. When the computer instructions are run on an electronic device, the electronic device is enabled to implement and execute part or all of the method described in the first aspect.

These aspects or other aspects of the present disclosure may be more concise and understandable in the description of the following embodiments.

### BRIEF DESCRIPTION OF THE DRAWINGS

In order to illustrate the embodiments of the present disclosure or the technical solutions in the prior art more clearly, the drawings to be used in the description of the embodiments or the prior art will be briefly explained below. Obviously, the drawings in the description below are only embodiments of the present disclosure. Other drawings can be obtained according to these drawings without any creative effort by those skilled in the art.

FIG. 1 is a schematic flowchart of a neural network computation method provided by an embodiment of the present disclosure.

FIG. 2 is a schematic flowchart of another neural network computation method provided by an embodiment of the present disclosure.

FIG. 3A is a schematic architecture diagram of a neural network.

FIG. 3B is a schematic diagram of a computation process adopting an existing method.

FIG. 3C is a schematic diagram of another computation process adopting the existing method.

FIG. 3D is a schematic diagram of a computation process adopting the method provided in the present disclosure.

FIG. 4 is a schematic diagram of a structure of a neural network computing device provided by an embodiment of the present disclosure.

FIG. 5 is a schematic diagram of a structure of another neural network computing device provided by an embodiment of the present disclosure.

### DETAILED DESCRIPTION OF THE EMBODIMENTS

The followings are detailed description.

Terms such as “first”, “second”, “third”, and “fourth” in the specification, the claims, and the drawings are used for distinguishing different objects rather than describing a specific order. In addition, terms such as “include”, “have”, and any variant thereof are used for indicating non-exclusive inclusion. For instance, a process, a method, a system, a product, or an equipment including a series of steps or units is not limited to the listed steps or units, but optionally includes steps or units that are not listed, or optionally includes other steps or units inherent to the process, the method, the product, or the equipment.

Reference to “embodiment” means that a particular feature, a structure, or a characteristic described in conjunction with the embodiment may be included in at least one example of the present disclosure. The term used in various places in the specification does not necessarily refer to the same embodiment, nor does it refer to an embodiment that is mutually exclusive, independent, or alternative to other embodiments. It can be explicitly and implicitly understood by those skilled in the art that the embodiments described herein may be combined with other embodiments.

“Multiple” means two or more. “And/or” describes the correlative relationship of associated objects, and indicates that there may be three types of relationships. For example, A and/or B may represent three situations: A exists alone, both A and B exist simultaneously, and B exists alone. The character “/” generally indicates that the previous and next associated objects are in an “or” relationship.

The following is an explanatory description of the relevant terms in the present disclosure.

Data arrangement is a descriptor that describes the relationship between data arrangement and natural semantics of data. Common data arrangement types include channels last and channels first, where channels last means that a channel dimension of input data is placed in the lowest dimension, abbreviated as CL. Channels first means that a channel dimension of input data is placed in the highest dimension, abbreviated as CF. Taking four-dimensional data as an example, NHWC and NCHW correspond to channels last and channels first respectively. For two-dimensional data, data arrangement types also include HW or WH, where N represents quantity, C represents the number of channels, H represents height, and W represents width.

An operator is a basic unit for performing various mathematical operations, such as addition, subtraction, multiplication, division, convolution, pooling, and so on. From the perspective of data arrangement, operators may be simply divided into two categories: data-arrangement-sensitive operators and data-arrangement-insensitive operators.

Data-arrangement-sensitive operators are operators that can only process inputs of a specific data arrangement or have a great performance advantage under a certain specific data arrangement, such as convolution operators, pooling operators, batch normalization operators, and layer normalization operators.

Data-arrangement-insensitive operators are operators that have no restrictions on data arrangement of inputs and have no obvious performance differences when processing inputs of various data arrangements, such as addition and subtraction operators, absolute value operators, and logarithm operators.

The embodiments of the present disclosure are described below in conjunction with the drawings.

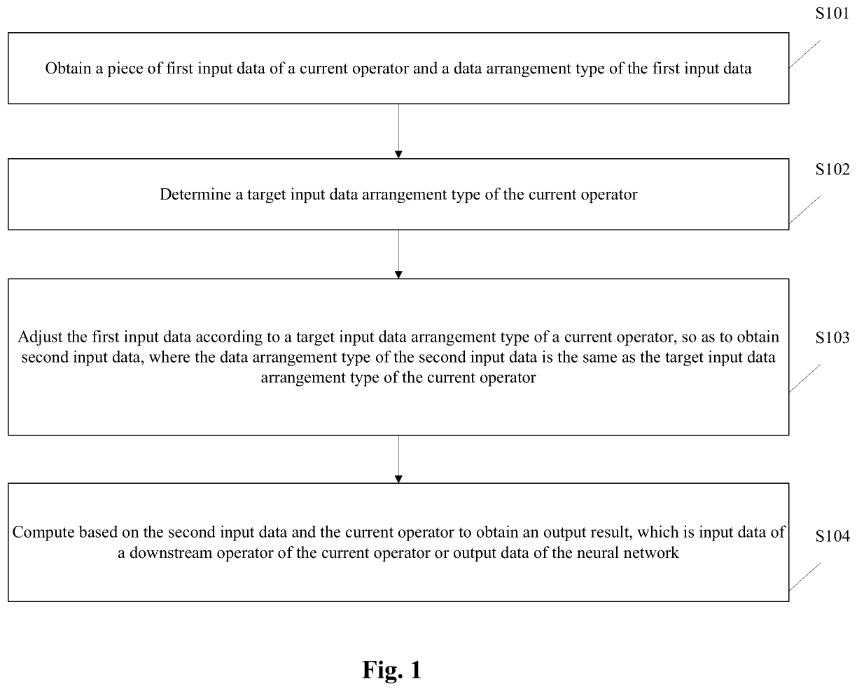

FIG. 1 is a schematic flowchart of an artificial neural network computation method provided by an embodiment of the present disclosure, where the method is applied to a processor. As shown in FIG. 1, the method includes:

S101, obtaining a piece of first input data of a current operator and a data arrangement type of the first input data,
where the first input data refers to actual original input data of the current operator, which may be data output by other operators or data obtained from other storage devices and participates in an operation of the current operator.

A data arrangement type is used to represent the type of data arrangement that represents the relationship between the data arrangement and natural semantics of the data.

Optionally, the data arrangement type of the first input data may be determined according to one or more of information such as a data arrangement identifier, a stride, a data type, a shape, a device type storing the first input data, and so on of the first input data.

The data arrangement identifier of the first input data is used to indicate the data arrangement type of the first input data. Common data arrangement types indicated by the data arrangement identifier include channels last and channels first, where channels last means that a channel dimension of the input data is placed in a lowest dimension, such as HWC, and channels first means that the channel dimension of the input data is placed in a highest dimension, such as CHW, where C represents the number of channels, and H represents height, and W represents width.

Data type refers to a storage type of data, and common ones include float, half, int, long, and so on.

The shape of data refers to the dimensional information of the data and the length information in each dimension. For example, the shape of the data is a two-dimensional matrix or a three-dimensional matrix.

S102, determining a target input data arrangement type of the current operator.

The target input data arrangement type refers to a data arrangement type of data that does not affect the efficiency of computation using the current operator or does not result in an uncomputed state using the current operator. For example, some operators can only process inputs of specific data arrangement, and the target input data arrangement refers to the input data arrangement type that meets the operator's requirements; or some operators have great performance advantages under a certain data arrangement, and the target input data arrangement type refers to the data arrangement type that enables the operator to have a great performance advantage.

In a feasible embodiment, when the current operator is a data-arrangement-sensitive operator, a target input data arrangement type of the current operator is determined according to a data arrangement requirement of the current operator. The data arrangement requirement refers to that only a specific data arrangement input can be processed or a performance advantage is provided under a certain specific data arrangement. When the current operator is a data-arrangement-insensitive operator, the target input data arrangement type of the current operator is determined according to a data arrangement type of the first input data. When the current operator is a data-arrangement-insensitive operator, it indicates that the current operator has no limit on the data arrangement input, and there is no obvious performance difference when processing inputs of various data arrangements. In order to reduce memory overhead and improve computation speed, the data arrangement type of the original input data (in other words, the first input data) of the current operator can be directly determined as the target input data arrangement type of the current operator.

S103, adjusting the first input data according to the target input data arrangement type of the current operator, so as to obtain a piece of second input data. The data arrangement type of the second input data is the same as the target input data arrangement type of the current operator.

It can be seen from step S102 that the target input data arrangement type is the data arrangement type of data of a state in which the current operator can perform computation or a data arrangement type which may fully utilize the performance of the current operator. However, the first input data is the current actual original input data, the current first data is not necessarily the same as the target input data arrangement type. Therefore the first input data needs to be adjusted according to the target data arrangement type of the operator.

In the present disclosure, based on a target input data arrangement type, the first input data may be dynamically adjusted, an input of the operator is adjusted only when necessary, and an output of the operator is not adjusted. By means of dynamic adjustment of the data arrangement type of the first input data, the data arrangement during neural network computation may no longer be individually fixed.

In an optional embodiment, operators include data-arrangement-sensitive operators and data-arrangement-insensitive operators, where the data-arrangement-sensitive operators can only process an input of a specific data arrangement, or have a great performance advantage under a certain specific data arrangement; and the data-arrangement-insensitive operators have no limit on the data arrangement input, and have no obvious performance difference when processing an input of various data arrangements. Further, the target data arrangement type is determined based on whether an operator is a data-arrangement-sensitive operator. Since the data-arrangement-sensitive operator is sensitive to a data arrangement type of input data, if the data arrangement type of the input data is inconsistent with a data arrangement type required by the data-arrangement-sensitive operator itself, computation efficiency may be reduced when the data-arrangement-sensitive operator and the input data are used for computation, and even the computation may not be possible. Therefore, if the current operator is a data-arrangement-sensitive operator, a target input data arrangement type and a target output data arrangement type of the current operator are determined based on the data arrangement requirement of the current operator. Here, the data arrangement requirement of the current operator refers to the data arrangement type of input data and the data arrangement type of output data required when the current operator is used for computation. For example, the data arrangement requirement of the current operator is that the data arrangement type of the input data and the data arrangement type of the output data required by the current operator are data arrangement type A respectively, and the target input data arrangement type of the current operator is data arrangement type A. However, the data-arrangement-insensitive operator has no requirements on the data arrangement type of input data and the data arrangement type of output data, that is to say, with regard to input data of any data arrangement type, computation can be performed correctly by the data-arrangement-insensitive operator. Furthermore, the computation efficiency is not affected, and therefore, when the current operator is a data-arrangement-insensitive operator, the target input data arrangement type of the current operator is the data arrangement type of the first input data, in other words, the data arrangement type of the first input data is used as the target input data arrangement type of the current operator.

The target input data arrangement type and the target output data arrangement type of the current operator are determined based on whether the current operator is a data-arrangement-sensitive operator, so that it is convenient to determine, during subsequent computation, whether a data arrangement conversion needs to be performed on input data. Thus the data arrangement conversion is performed on the input data when necessary, unnecessary data arrangement conversion is avoided, memory overheads are reduced, and computation efficiency is improved.

Further, when the target input data arrangement type of the current operator is determined according to the data arrangement requirement of the current operator, performing data arrangement conversion on the first input data to obtain the second input data. When the target input data arrangement type of the current operator is determined according to the data arrangement type of the first input data, the first input data is directly taken as the second input data instead of being converted.

It can be seen from the above that there are two methods for determining the target input data arrangement type of the current operator: one is determined based on the data arrangement requirement of the current operator, and the second is determined based on the data arrangement type of the first input data.

Specifically, when the target input data arrangement type of the current operator is determined based on the data arrangement requirement of the current operator, in other words, when the current operator is the data-arrangement-sensitive operator, it is necessary to perform data arrangement conversion on the first input data, so as to obtain the second input data, where the data arrangement type of the second input data is the target input data arrangement type of the current operator, so that the data arrangement type of the second input data satisfies the requirement of the current operator for the data arrangement type of the input data. When the target input data arrangement type of the current operator is determined according to the data arrangement type of the first input data, in other words, when the current operator is a data-arrangement-insensitive operator, the first input data is determined as the second input data. The computation may be performed according to the first input data and the current operator without performing a data arrangement conversion on the first input data, so as to obtain an output result, thereby avoiding unnecessary data arrangement conversion.

In a possible embodiment, before performing the data arrangement conversion on the first input data to obtain the second input data, the method of the present disclosure further includes:

determining whether a data arrangement type of first input data is the same as a target input data arrangement type of a current operator, when the data arrangement type of the first input data is different from the target input data arrangement type of the current operator, an operation of performing a data arrangement conversion on the first data to obtain second input data is executed. When the data arrangement type of the first input data is the same as the target input data arrangement type of the current operator, the first input data is taken as the second input data.

It is determined whether to perform data arrangement conversion on the first data by adding a condition before performing the data arrangement conversion on the first data. The condition may be: whether the data arrangement type of the first input data is the same as the type of the target input data arrangement of the current operator, in other words, whether the data arrangement type of the first input data satisfies the requirement of the current operator for the data arrangement of the input data. When the data arrangement type of the first input data is the same as the target input data arrangement type of the current operator, in other words, when the data arrangement type of the first input data satisfies the requirement of the current operator for the data arrangement of the input data, the operation of performing the data arrangement conversion on the first input data does not need to be executed, and the first input data can be taken as the second input data to participate in subsequent computations. When the data arrangement type of the first input data is different from the target input data arrangement type of the current operator, in other words, when the data arrangement type of the first input data does not meet the requirement of the current operator for the data arrangement of the input data, the data arrangement conversion is performed on the first input data to obtain the second input data, thereby avoiding the occurrence of the case where the data arrangement conversion is performed on the first input data when the data arrangement type of the first input data is the same as the target input data arrangement type of the current operator. The unnecessary data arrangement conversion is thus avoided.

S104, computing based on the second input data and the current operator to obtain an output result, which is a piece of input data of a downstream operator of the current operator or a piece of output data of the neural network.

Specifically, the second input data is input into the current operator for computation, so as to obtain an output result; and then the output result is taken as input data of the downstream operator of the current operator. In the prior art, after the output result is obtained, it needs to be determined whether a data arrangement type of the output result is the same as a uniform data arrangement type. When they are not the same, data arrangement conversion needs to be performed on the output result. In this way, when the uniform data arrangement type is inconsistent with the target input data arrangement type of the current operator, and a data arrangement type of a computation result obtained based on an upstream operator of the current operator is consistent with the target input data arrangement type of the current operator, first, it is necessary to perform data arrangement conversion on the computation result, so as to obtain data of which the data arrangement type is consistent with the uniform data arrangement type. If the current operator is the data-arrangement-sensitive operator, and before the data is computed using the current operator, the data arrangement conversion needs to be performed on the data, so as to obtain data of which the data arrangement type is consistent with the target input data arrangement type of the current operator. If after the computation result is output by the upstream operator of the current operator, the data arrangement conversion is not performed on the computation result, the computation result may be made to participate in the computation of the current operator. Therefore, in order to avoid unnecessary data arrangement conversion, in the present disclosure, after the computation result is obtained based on the current operator, the computation result is directly taken as the input data of the downstream operator of the current operator. Because the number of times of the data arrangement conversion is reduced, intermediate results obtained by the data arrangement conversion are also reduced, thereby reducing memory overheads.

It should be noted that, the downstream operator of the current operator specifically refers to an operator participating in the computation based on the output result obtained by computation of the current operator. It is assumed that the neural network has a ring structure, for example, operator 1->operator 2->operator 3->operator 1, for operator 1, its downstream operator is operator 2; and for operator 3, its downstream operator is operator 1. It is assumed that the described neural network has two branches, for example, a first branch is: operator 1->operator 2->operator 3; and the second branch is: operator 1->operator 4->operator 5. For operator 1, its downstream operator includes operator 2 and operator 4.

With regard to a single-link neural network, when a current operator is a last operator in the single-link neural network, an output result obtained by computation according to second input data and the current operator is output data of the neural network.

In an example, the method of the present disclosure further includes:

after an output result is obtained, setting a data type, a shape, a stride length, a data arrangement identifier and a device type for the output result; then allocating a memory on a corresponding device based on the data type and the shape, and finally writing an output result into the memory; where the data arrangement identifier is used to indicate a data arrangement type of an output result, in other words, a target output data arrangement type of a current operator.

It should be noted herein that the data-arrangement-sensitive operator refers to an operator that can only process a specific data arrangement input, or has a great performance advantage in processing a certain specific data arrangement, such as convolution, pooling, batch normalization, and layer normalization operators.

By way of example, an operator having any of the following characteristics may be referred to as a data-arrangement-sensitive operator:
1. An operator that has an explicit requirement on the data arrangement type of the input data, such as convolution and batch normalization operators, which requires the data arrangement type of the input data to be CL, where CL is the abbreviation of channel last.
2. An operator that has no explicit requirement on the data arrangement type of the input data, but whose the input data contains tensors such as mask, index, and so on, which are related to the order of input data arrangement, for example, operators such as index and index put and so on.

Here, it should be noted that, the mask operator needs to perform an operation according to a position element corresponding to a flag bit, and two-dimensional data is taken as an example for description:

Assuming that the mask operator of the data arrangement type HW is:

$$\begin{matrix}1 & 0 & 1 \\ 0 & 0 & 1 \\ 0 & 1 & 0\end{matrix} ,$$

the mask operator of the data arrangement type WH is:

$$\begin{matrix}1 & 0 & 0 \\ 0 & 0 & 1 \\ 1 & 1 & 0\end{matrix} ,$$

and the input data of the data arrangement type HW is:

$$\begin{matrix}1 & 2 & 3 \\ 4 & 5 & 6 \\ 7 & 8 & 9\end{matrix} ,$$

if the input data is input into the mask operator of the data arrangement type HW, the resulting data is

$$\begin{matrix}1 & 0 & 3 \\ 0 & 0 & 6 \\ 0 & 8 & 0\end{matrix} ,$$

and if the input data is input into the mask operator of the data arrangement type WH, the resulting data is:

$$\begin{matrix}1 & 0 & 0 \\ 0 & 0 & 6 \\ 7 & 8 & 0\end{matrix} .$$

It can be seen therefrom that when input data includes a tensor related to an input data arrangement sequence, different data arrangement sequences affect the computation result, and if the data arrangement type of the input data is inconsistent with the target input data arrangement type of an operator, an erroneous result may be obtained, thereby causing an error in a subsequent computation process.

It should be noted that the size of the mask does not need to be consistent with the size of the input data, as long as the number of elements in the mask is the same as the number of elements in the input data. For example, the mask operator of the data arrangement type HW mentioned above may be: 1 0 1 0 0 1 0 1 0, and this can be seen as an index operator.
3. An operator included in dimension-raising and dimension-lowering scenes, which needs to be processed as a data-arrangement-sensitive operator in dimension-raising and dimension-lowering scenes, and in non-ascending dimension scenes, may be processed as a data-arrangement-insensitive operator such as repeat, reduce op, and so on.

It should be noted herein that the dimension-raising refers to that the dimension of input data is lower than the dimension of output data, and the dimension-lowering refers to that the dimension of input data is higher than the dimension of output data.
4. An operator that relies on dimension adjacency, such as a view operator.

Some operators have a constraint of an adjacent relationship between data dimensions. For example, a basic function of a view operator is dimension splitting and dimension merging. The dimensional merging is: input (2*3*4*5)->output (2*12*5). It can be seen that a first dimension and a second dimension are merged, and the dimensional counting starts from zero. The dimensional splitting is: input (4*5*6)->output (4*5*3*2), where the second dimension is split.

The data-arrangement-insensitive operator is an operator that has no limitation on the data arrangement type of the input data, and has no obvious performance difference when the input data of various data arrangement types are processed, for example, operators such as addition, subtraction, absolute value and logarithm operators.

To illustrate, an operator having any of the following features may be referred to as a data-arrangement-insensitive operator:
1. An operator with the same computation logic for all input elements, such as log, sin, and abs operators.

A Log operator, a sin operator and an abs operator perform a log operation, a sin computation and an absolute value computation on each element in the input data, and there is no requirement on the data arrangement type of the input data.
2. An operator that operates on specified dimensions and does not depend on a dimension adjacency, for example, operators such as transpose and permute operators.

The transpose operator may be understood as a transpose function of a two-dimensional matrix; and the permute operator may be understood as a transpose function of a high-dimensional matrix (for example, a three-dimensional matrix or a four-dimensional matrix).
3. Other data-arrangement-insensitive operators, such as addition, subtraction, multiplication, and division operators.

In other words, operators other than the data-arrangement-sensitive operators may be referred to as data-arrangement-insensitive operators.

In a feasible embodiment, when the first input data includes a plurality of pieces of input data, the data arrangement types of the first input data include a plurality of data arrangement types corresponding to the plurality of pieces of input data. The plurality of pieces of input data corresponds to one or more target data arrangement types. Specifically, the target data arrangement types corresponding to each input data may be the same or different, and the number of its target data arrangement type is less than or equal to the number of input data. The plurality of target data arrangement types may be respectively the same as the data arrangement types of the plurality of pieces of input data of the first data, and may also be one or more data arrangement types of the plurality of pieces of input data of the first data, and may also be completely different from the data arrangement types of the plurality of pieces of input data of the first data, which is not limited in the present disclosure.

Specifically, when the current operator is a data-arrangement-insensitive operator, determining the target input data arrangement type of the current operator includes:
arbitrarily selecting one of the data arrangement types corresponding to the plurality of pieces of input data as the target input data arrangement type of the current operator; or
determining the target input data arrangement type of the current operator according to the plurality of data arrangement types corresponding to the plurality of pieces of input data and a plurality of memories occupied by the plurality of pieces of input data.

When the current operator is a data-arrangement-insensitive operator, it indicates that the current operator has no specific requirement on the data arrangements of input data, and there is no obvious performance difference when processing inputs of various data arrangements. Therefore, a plurality of target data arrangement types corresponding to the plurality of data arrangement types of a plurality of pieces of input data may be the same target data arrangement type, and in this case, it may be considered that the plurality of pieces of input data correspond to one target data arrangement type. The target data arrangement type may be any one of the data arrangement types corresponding to the plurality of pieces of input data, or the target data arrangement type is determined according to a memory of each input data.

Further, determining the target input data arrangement type of the current operator according to the plurality of data arrangement types corresponding to the plurality of pieces of input data and the plurality of memories occupied by the plurality of pieces of input data includes:
respectively accumulating memories occupied by input data of the same data arrangement type among the plurality of pieces of input data; determining a data arrangement type corresponding to a maximum memory accumulation result as the target input data arrangement type of the current operator.

In an optional embodiment, when the current operator is a data-arrangement-insensitive operator, the first input data may also correspond to a plurality of target data arrangement types, the plurality of target data arrangement types may be respectively the same as the plurality of pieces of input data of the first data, and may also be one or more of the plurality of pieces of input data of the first data. Further, when the first input data includes the plurality of pieces of input data, the current operator is a multi-input single-output operator, that is to say, the first input data of the current operator includes the plurality of pieces of input data, the data arrangement types of the first input data include the plurality of pieces of input data respectively corresponding to the plurality of data arrangement types, and the target number of input data arrangement types of the current operator include a plurality of input data arrangement types. It is determined whether the current operator is a data-arrangement-sensitive operator, and the specific determination method may refer to the related description above, and will not be described herein again.

When the current operator is the data-arrangement-sensitive operator, the target input data arrangement type of the current operator is determined according to the data arrangement requirement of the current operator. When the current operator is the data-arrangement-insensitive operator, the target input data arrangement type of the current operator is any one of the plurality of data arrangement types respectively corresponding to the plurality of pieces of input data, or the target input data arrangement type of the current operator is determined according to memories respectively occupied by the plurality of pieces of input data. The specific method is: respectively accumulating occupied memories of input data of the same data arrangement type among the plurality of pieces of input data; determining a data arrangement type corresponding to a maximum memory accumulation result as the target input data arrangement type of the current operator. For example, there are 5 pieces of input data, the memories occupied by them are 3k, 4k, 1k, 5k, and 3k respectively, and five data arrangement types corresponding to the five input data are respectively a data arrangement A, a data arrangement type B, a data arrangement type A, a data arrangement type C and a data arrangement type B. Processing is performed according to the described method, and the result obtained is: the memory accumulation result occupied by the input data of the data arrangement type A is 4k; the memory accumulation result occupied by input data of the data arrangement type B is 7k; the memory accumulation result occupied by input data of the data arrangement type C is 5 k; and the memory occupied by the input data of the data arrangement type B is the largest, and therefore the target input data arrangement type of the current operator is the data arrangement type B.

When the current operator includes the plurality of pieces of input data, the target input data arrangement type of the current operator above includes target input data arrangement types corresponding to the plurality of pieces of input data. When the current operator is the data-arrangement-insensitive operator, target input data arrangement types corresponding to the plurality of pieces of input data are the same, and may be unified as any one of the plurality of input data arrangement types corresponding to the plurality of pieces of input data or a data arrangement type determined according to a memory mode. When the current operator is the data-arrangement-sensitive operator, the target input data arrangement types corresponding to the plurality of pieces of input data are determined based on the data arrangement requirement of the current operator.

When it is determined based on the data arrangement requirement of the current operator, data arrangement conversion is performed on the plurality of pieces of input data to obtain the plurality of pieces of converted input data. The data arrangement types of the converted plurality of pieces of input data are the same as the target input data arrangement types corresponding to the plurality of pieces of input data. Optionally, among the plurality of pieces of input data, there may be input data with the same data arrangement type before and after conversion. With regard to these input data, it is not necessary to convert the data arrangement. In order to avoid performing a data arrangement conversion operation on input data which does not require data arrangement conversion, before the conversion, with regard to each of input data in the plurality of pieces of input data, it is judged whether a data arrangement type corresponding thereto is the same as a target input data arrangement type corresponding thereto. If not, data arrangement conversion is performed on the input data; and if yes, data arrangement conversion is not performed on the input data. For example, there are three pieces of input data, and the corresponding data arrangement types are respectively a data arrangement type A, a data arrangement type B and a data arrangement type C. It is determined that the three target input data arrangement types of the first operator are all the data arrangement type A according to the described method. It can be seen that the data arrangement types of the second input data and the third input data in the three pieces of input data are different from the corresponding data arrangement types thereof. Before computation, the data arrangement conversion needs to be performed on the second input data and the third input data. The data arrangement type of the converted input data is the data arrangement type A, and the data arrangement conversion does not need to be performed on the first input data.

After the input data of the current operator is determined, computation is performed on the input data according to the current operator, so as to obtain an output result.

In another specific example, when the current operator is a single-input multiple-output operator, the target output data arrangement type of the current operator includes a plurality of target output data arrangement types. When the current operator is a data-arrangement-sensitive operator, the plurality of target output data arrangement types are determined according to the data arrangement requirement of the current operator. When the current operator is a data-arrangement-insensitive operator, the plurality of target output data arrangement types are the same as the target input data arrangement type.

In another specific example, the current operator is a multiple-input multiple-output operator, and a manner of determining the plurality of input data arrangement types and the plurality of output data arrangement types of the current operator may be determined according to the foregoing manner, which is not described herein again.

In the present disclosure, the target input data arrangement type of the current operator is determined by judging whether the operator is a data-arrangement-sensitive operator or a data-arrangement-insensitive operator. Based on the first input data of the current operator and the target input data arrangement type, the first input data can be dynamically adjusted, and the input of the operator is adjusted only when necessary, and the output of the operator is not adjusted. By dynamically adjusting the data arrangement type of the first input data, the data arrangement in the neural network computation is no longer fixed and uniform. Further, it can reduce unnecessary data arrangement conversion, especially it is not needed to convert the data arrangement type of the output data, and at most only the data arrangement type conversion is performed on the input data. This can reduce the number of data arrangement conversions, speed up the computation, and decrease memory overhead. The following examples illustrate the beneficial effects of the method of the present disclosure:

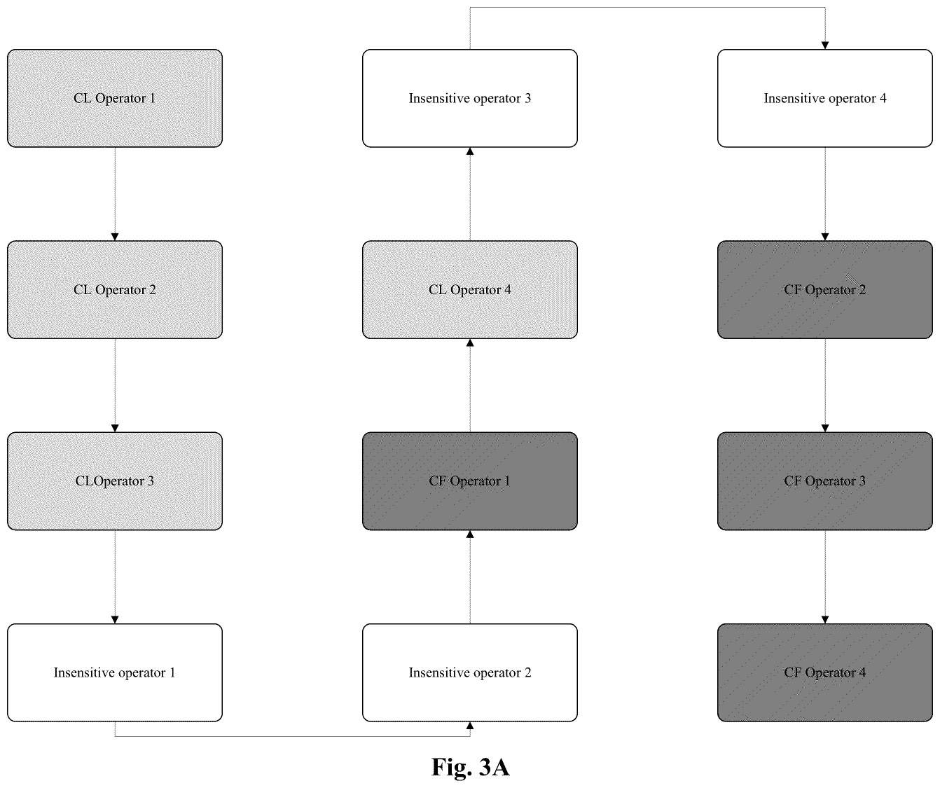

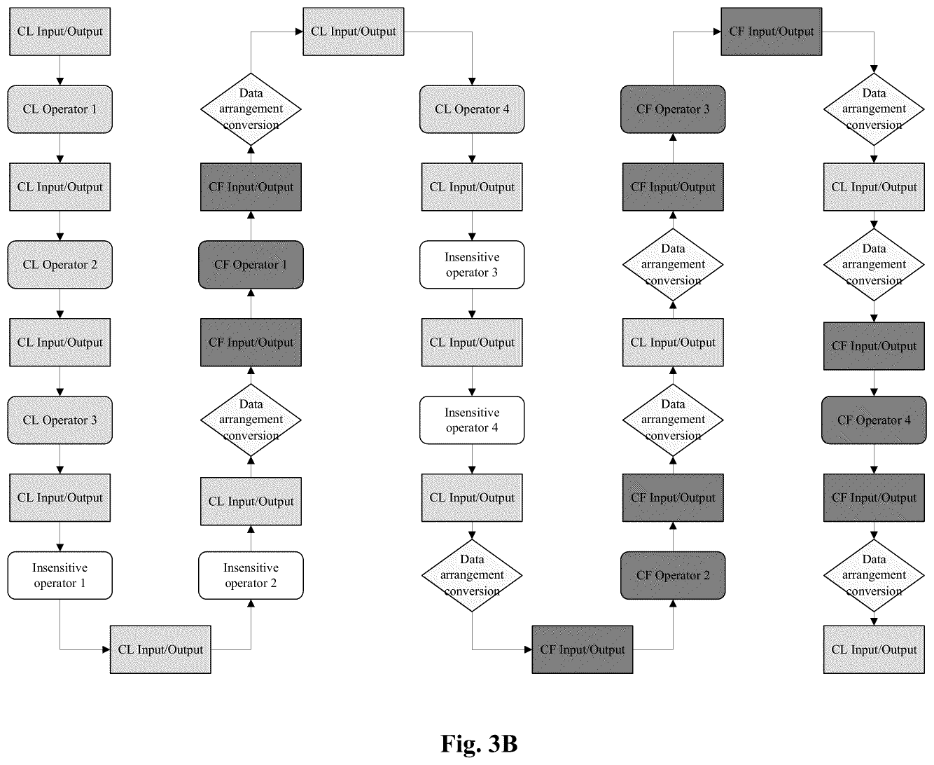

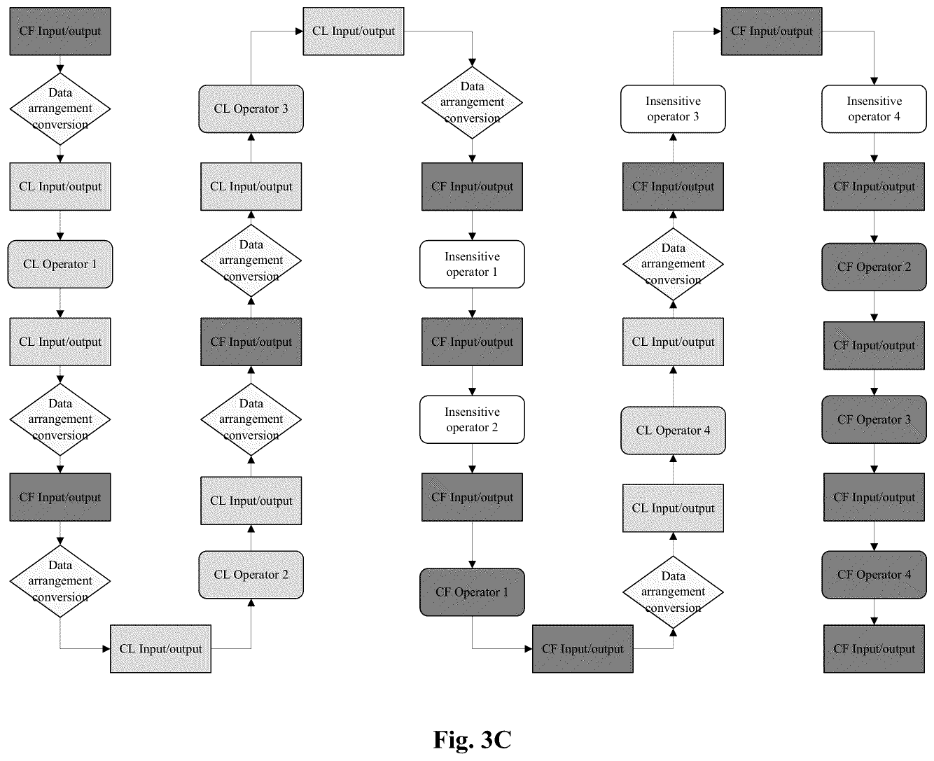

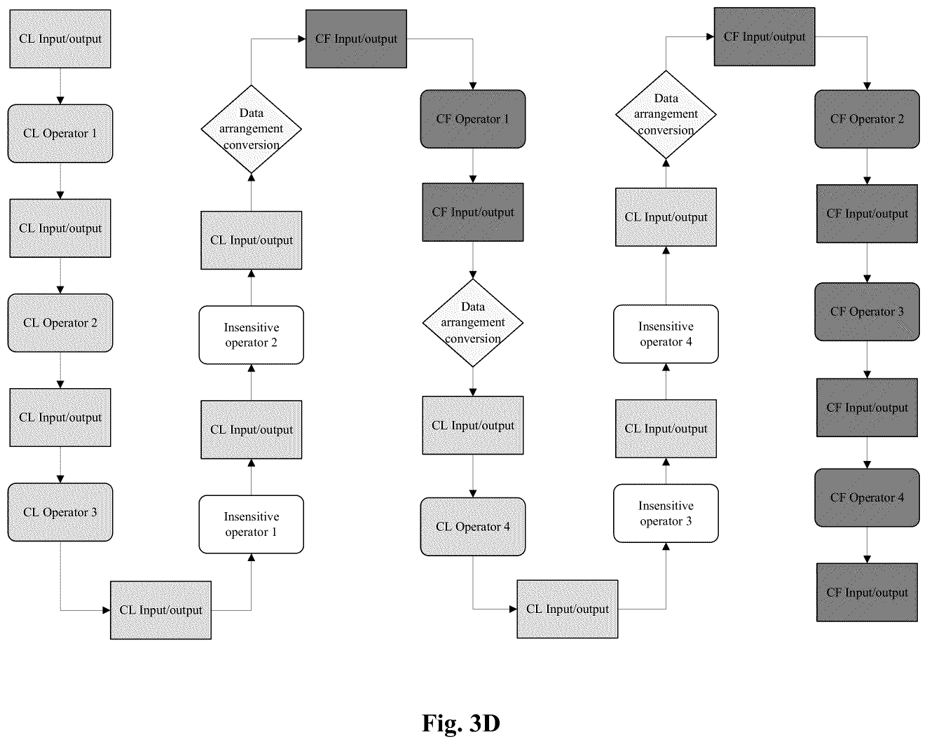

Taking a network containing three types of operators (CL operator, CF operator and data arrangement insensitive operator) as an example, as shown in FIG. 3A. Channels last data-arrangement-sensitive operator: the input data and output data must be operators of channels last data arrangement, referred to as CL operator. When the network data arrangement is fixed to channels last, this type of operator needs to insert data arrangement conversions before its input and after its output. Channels first data-arrangement-sensitive operator: the input and the output must be operators of channels first data arrangement, referred to as CF operator. When the network data arrangement is fixed to channels first, this type of operator needs to insert data arrangement conversions before its input and after its output.

As shown in FIG. 3B, when the uniform data arrangement type of the network shown in FIG. 3A is fixed as channels last, the network inserts 8 data arrangement conversions during the execution, and the data arrangement conversions bring 8 computational intermediate quantities (CF input/output).

Specifically, the data arrangement types of both the input data and the output data of the CL operator are CL, so for a CL operator 1, a CL operator 2 and a CL operator 3, no data arrangement conversion is required; and for an insensitive operator 1 and an insensitive operator 2, no data arrangement conversion is required. Since the data arrangement type transmitted between the insensitive operator 2 and the CF operator 1 is CL, before the data output by the insensitive operator 2 is input to the CF operator 1, it needs to perform a data arrangement conversion on the data (a first data arrangement conversion) to obtain input data 1 with a data arrangement type of CF. Then, the input data 1 is computed based on the CF operator 1 to obtain output data 2 with an output data arrangement type of CF. Due to the data arrangement type transmitted between operators is CL, so the output data 2 is subjected to a data arrangement conversion (a second data arrangement conversion) to obtain an output result with a data arrangement type of CL. For a CL operator 4, an insensitive operator 3 and an insensitive operator 4, no data arrangement conversion is required. Since the data arrangement type of the input data is CL, and the data arrangement type of the data transmitted between the operators requires CL, for the CF operator 2, the CF operator 3 and the CF operator 4, a data arrangement conversion is required before and after the computation, and 6 pieces of CF input data or output data will be generated. It can be seen that during the computation shown in FIG. 3B, 8 data arrangement conversions are performed, and 8 pieces of CF input data/output data are obtained due to the 8 data arrangement conversions.

As shown in FIG. 3C, when the uniform data arrangement type of the network shown in FIG. 3A is fixed to channels first, the network inserts 8 data arrangement conversions during the execution, and the data arrangement conversions bring 8 computational intermediate quantities (CL input/output).

Specifically, the data arrangement types of both the input data and the output data of the CL operator are CL, and the data arrangement type transmitted between operators is CF, so for each of the CL operator 1, the CL operator 2 and the CL operator 3, a data arrangement conversion is required before and after the computation, and 6 pieces of CL input data or output data will be generated. For the insensitive operator 1, the insensitive operator 2 and the CF operator 1, no data arrangement conversion is required. Since the data arrangement type transmitted between the CF operator 2 and the CL operator 4 is CF, before the data output by the CF operator 1 is input into the CL operator 4, it is necessary to perform a data arrangement conversion on the data (a seventh data arrangement conversion) to obtain input data with a data arrangement type of CL; then the input data is computed based on the CL operator 4 to obtain output data with an output data arrangement type of CL. Since the data arrangement type of data transmitted between operators is CF, a data arrangement conversion is performed on the output data (an eighth data arrangement conversion) to obtain an output result with the data arrangement type of CF. For the insensitive operator 3, the insensitive operator 4, the CF operator 2, the CF operator 3 and the CF operator 4, no data arrangement conversion is required. It can be seen that during the computation shown in FIG. 3C, 8 data arrangement conversions are performed, and 8 pieces of CL input data/output data are obtained due to the 8 data arrangement conversions.

As shown in FIG. 3D, in the process of executing the above network using the method of the present disclosure, 3 data arrangement conversions are inserted, and the data arrangement conversions bring about 3 computational intermediate quantities.

Specifically, the data arrangement type of the input data of the entire network is CL. Since the data arrangement types of the input data and output data of the CL operator are both CL, there is no need to perform data arrangement conversion for the CL operator 1, the CL operator 2, and the CL operator 3; and there is no need to perform data arrangement conversion for the insensitive operator 1 and the insensitive operator 2. For the insensitive operator 2, since the data arrangement type of its output data is the same as the data arrangement type of its input data, which both are CL, and for the operator of a downstream node, which is the CF operator 1, it is necessary to perform data arrangement conversion (the first data arrangement conversion) on the input data (the output data of the insensitive operator 2) to obtain an intermediate result 1 with the data arrangement type of CF. Then the CF operator 1 computes the intermediate result 1 with the data arrangement type of CF to obtain an output result 1 with the data arrangement type of CF. A downstream node of the CF operator 1 is the CL operator 4, and it is needed to perform data arrangement conversion on the output result 1 (the second data arrangement conversion) to obtain an intermediate result 2 with the data arrangement type of CL. Then the CL operator 4 computes the intermediate result 2 of CL to obtain an output result 2 with the data arrangement type of CL. For downstream nodes of the CL operator 4 (the insensitive operator 3 and the insensitive operator 4), no data arrangement conversion is required. For the insensitive operator 4, since the data arrangement type of its output data is the same as the data arrangement type of its input data, which both are CL, and for a downstream operator of insensitive operator 4 (the CF operator 2), since the data arrangement type of its input data is CL, it is necessary to perform data arrangement conversion on the input data to obtain an intermediate result 3 with the data arrangement type of CF (the third data arrangement conversion). Then the intermediate result 3 is computed based on the CF operator 2 to obtain an output result 3 with the data arrangement type of CF. For downstream nodes of the CF operator 2 (the CF operator 3 and the CF operator 4), the data arrangement type of the input data is CF, and no data arrangement conversion is required. It can be seen that only 3 data arrangement conversions are performed during entire computation and 3 intermediate results are generated.

A comprehensive comparison of the execution shown in FIG. 3B, FIG. 3C and FIG. 3D shows that the dynamic data arrangement strategy of the present disclosure has fewer data arrangement conversions than traditional fixed data arrangement strategies, which can reduce computational quantities and speeding up the computation. It also brings fewer computational intermediate quantities, which can reduce memory overhead.

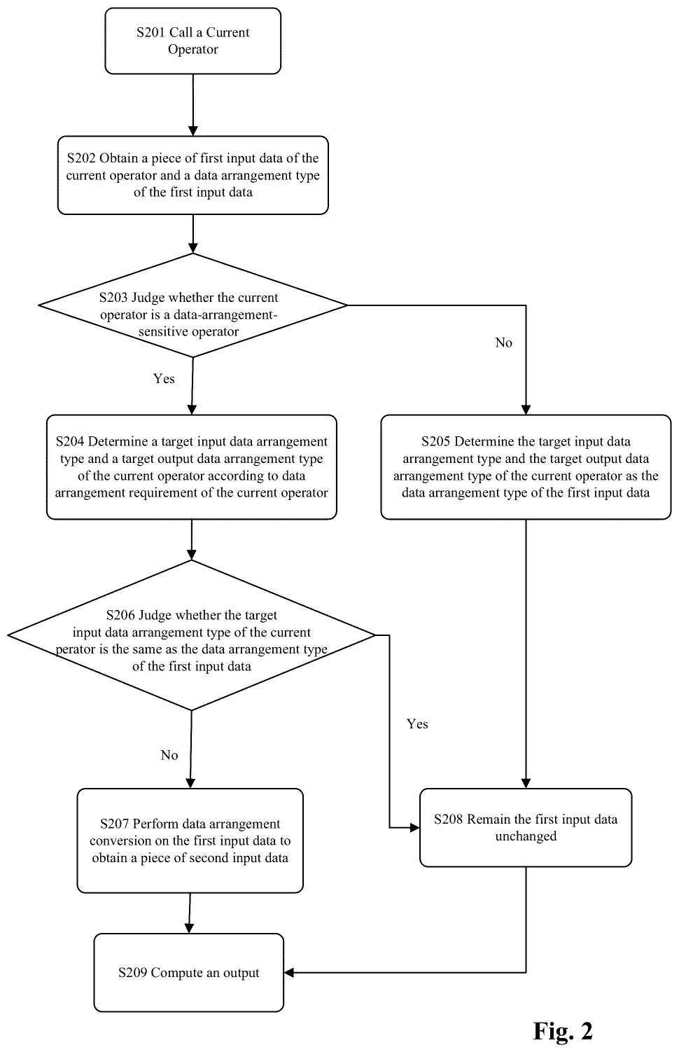

FIG. 2 is a schematic flowchart of another neural network computation method provided by an embodiment of the present disclosure. As shown in FIG. 2, the computation method includes the following steps.

S201, calling a current operator.

S202, obtaining a piece of first input data of the current operator and a data arrangement type of the first input data.

S203, judging whether the current operator is a data-arrangement-sensitive operator.

Specifically, if the current operator is a data-arrangement-sensitive operator, S204 is executed; otherwise, S205 is executed.

S204, determining a target input data arrangement type and a target output data arrangement type of the current operator according to data arrangement requirement of the current operator.

S205, determining the target input data arrangement type and the target output data arrangement type of the current operator as the data arrangement type of the first input data.

S206, judging whether the target input data arrangement type of the current operator is the same as the data arrangement type of the first input data.

If the target input data arrangement type of the current operator is the same as the data arrangement type of the first input data, S207 is executed; otherwise, S208 is executed.

S207, performing data arrangement conversion on the first input data to obtain a piece of second input data.

A data arrangement type of the second input data is the same as the target input data arrangement type of the current operator.

S208, remaining the first input data unchanged.

The first input data remains unchanged, which can be regarded as taking the first input data as the second input data to participate in subsequent computations.

S209, computing an output.

Specifically, the computation is performed based on the current operator and the second input data to obtain an output result.

In order to avoid the situation where the first input data is still subjected to a data arrangement conversion operation when the target input data arrangement type of the current operator is the same as the data arrangement type of the first input data, a judgment condition is added before the first input data is subjected to the data arrangement conversion: judging whether the target input data arrangement type of the current operator is the same as the data arrangement type of the first input data, where the data arrangement conversion is performed on the first input data only when the target input data arrangement type of the operator is different from the data arrangement type of the first input data, and when the target input data arrangement type of the current operator is the same as the data arrangement type of the first input data, it not needed to perform a data arrangement conversion on the first input data, and computation is performed directly based on the first input data and the current operator to obtain the output result.

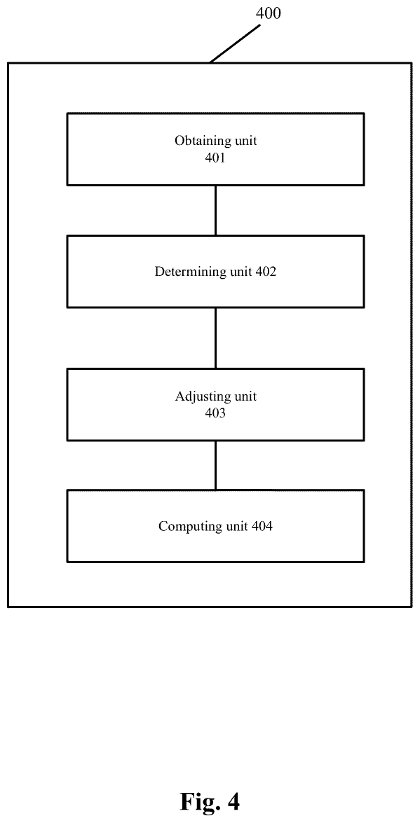

FIG. 4 is a schematic diagram of a structure of a neural network computing device provided by an embodiment of the present disclosure. As shown in FIG. 4, the computing device 400 includes:
an obtaining unit 401 configured to obtain a piece of first input data of a current operator and a data arrangement type of the first input data;
a determining unit 402 configured to determine a target input data arrangement type of the current operator;
an adjusting unit 403 configured to adjust the first input data according to the target input data arrangement type of the current operator to obtain a piece of second input data, where a data arrangement type of the second input data is the same as the target input data arrangement type of the current operator; and
a computing unit 404 configured to compute based on the current operator and the second input data to obtain an output result, which is a piece of input data of a downstream operator of the current operator or a piece of output data of the neural network.

In a feasible embodiment, the determining unit 402 is specifically configured to, when the current operator is a data-arrangement-sensitive operator, determine the target input data arrangement type of the current operator according to data arrangement requirement of the current operator.

Further, in a feasible embodiment, the adjusting unit 403 is specifically configured to perform a data arrangement conversion on the first input data to obtain the second input data.

In a feasible embodiment, the determining unit 402 is specifically configured to, when the current operator is a data-arrangement-insensitive operator, determine the target input data arrangement type of the current operator according to the data arrangement type of the first input data.

Further, in a feasible embodiment, the adjusting unit 403 is specifically configured to determine the first input data as the second input data.

In a feasible embodiment, the determining unit 402 is further configured to:
determine, before performing the data arrangement conversion on the first input data to obtain the second input data, whether the data arrangement type of the first input data is the same as the target input data arrangement type of the current operator; perform the data arrangement conversion on the first input data to obtain the second input data when the data arrangement type of the first input data is different from the target input data arrangement type of the current operator; and take the input data as the second input data when the data arrangement type of the first input data is the same as the target input data arrangement type of the current operator.

In a feasible embodiment, the first input data includes a plurality of pieces of input data, and the data arrangement type of the first input data includes a plurality of data arrangement types corresponding to the plurality of pieces of input data. When the current operator is a data-arrangement-insensitive operator, the determining unit is specifically configured to:
arbitrarily select one of the data arrangement types corresponding to the plurality of pieces of input data as the target input data arrangement type of the current operator; or
determine the target input data arrangement type of the current operator according to the plurality of data arrangement types corresponding to the plurality of pieces of input data and a plurality of memories occupied by the plurality of pieces of input data.

In a feasible embodiment, in terms of determining the target input data arrangement type of the current operator according to the plurality of data arrangement types corresponding to the plurality of pieces of input data and a plurality of memories occupied by the plurality of pieces of input data, the determining unit 402 is specifically configured to:
accumulate memories occupied by input data with the same data arrangement type among the plurality of pieces of input data respectively; and determine a data arrangement type corresponding to a maximum memory accumulation result as the target input data arrangement type of the current operator.

In a feasible embodiment, the target output data arrangement type of the current operator includes a plurality of target output data arrangement types. When the current operator is a data-arrangement-sensitive operator, the plurality of target output data arrangement types are determined according to the data arrangement requirement of the current operator; when the current operator is a data-arrangement-insensitive operator, the plurality of target output data arrangement types are the same as the target input data arrangement type of the current operator.

In a feasible embodiment, the data-arrangement-sensitive operator includes at least one of following operators:
an operator that has an explicit requirement on a data arrangement type of input data;
an operator that has no explicit requirement on the data arrangement type of the input data, but the input data contains a mask, an index, and a tensor related to arrangement of the input data; and
an operator whose input data dimension is different from an output dimension, or an operator that depends on an adjacent relationship of dimensions.

In a feasible embodiment, a data-arrangement-insensitive operator includes at least one of following operators:
an operator with the same computation logic for all input elements;
an operator that operates on a specified dimension and has no dependency on the adjacent relationship of the dimensions; and
an addition operator, a subtraction operator, a multiplication operator, or a division operator.

It should be noted that the above units (the obtaining unit 401, the determining unit 402, the adjusting unit 403, and the computing unit 404) are used to perform the relevant steps of the above method. For example, the obtaining unit 401 is configured to execute step S101, the determining unit 402 is configured to execute step S102, the adjusting unit 403 is configured to execute step S103, and the computing unit 404 is configured to execute step S104.

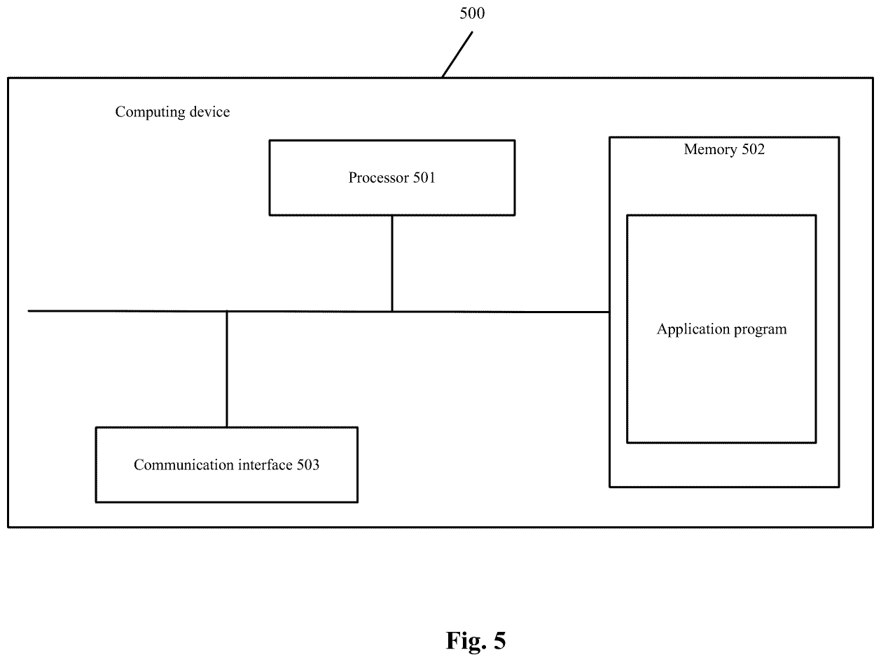

In this embodiment, the computing device 400 is presented as a unit. The term “unit” here may refer to an application-specific integrated circuit (ASIC), a processor and memory that executes one or more software or firmware programs, an integrated logic circuit, and/or other devices that can provide the above functions. In addition, the above obtaining unit 401, determining unit 402, adjusting unit 403, and computing unit 404 can be implemented by a processor 501 of the computing device shown in FIG. 5.

FIG. 5 is a schematic diagram of a structure of a neural network computing device provided by an embodiment of the present disclosure. The computing device 500 as shown in FIG. 5 (which may specifically be a computer device) includes a memory 502, a processor 501 and a communication interface 503. The memory 502, the processor 501 and the communication interface 503 communicate with each other through a bus.

The memory 502 can be a read only memory (ROM), a static storage device, a dynamic storage device, or a random access memory (RAM). The memory 502 may store programs, and when the programs stored in the memory 502 are executed by the processor 501, the processor 501 and the communication interface 503 are used to perform the steps of the neural network computation method of the embodiments in the present disclosure.

The processor 501 can adopt a general-purpose central processing unit (CPU), a microprocessor, an application specific integrated circuit (ASIC), a graphics processing unit (GPU) or one or more integrated circuits used to execute programs to implement the functions required to be performed by the units in the computing device of the embodiments in the present disclosure, or to perform a neural network computation method of the embodiments in the present disclosure.

The processor 501 can also be an integrated circuit chip with signal processing capabilities. In the implementation process, the various steps of the neural network computation method of the present disclosure may be completed by integrated logic circuits in hardware form or by instructions in software form in the processor 501. The processor 501 can also be a general-purpose processor, a digital signal processing processor (DSP), an application-specific integrated circuit (ASIC), a field programmable gate array (FPGA) or other programmable logic devices, discrete gate or transistor logic devices, or discrete hardware components. The methods, steps, and logic diagrams disclosed in the embodiments of the present disclosure can be implemented or executed. The general-purpose processor can be a microprocessor or any conventional processor. The steps of the methods disclosed in the embodiments of the present disclosure can be directly reflected as executing by hardware decoding processors, or by a combination of hardware and software modules within the decoding processor. The software modules can be located in mature storage media in this field, such as a RAM, a flash memory, an ROM, a programmable ROM, or an electrically erasable programmable memory, a register, and the like. These storage media are located in the memory 502, and the processor 501 reads information from the memory 502, combining its hardware to perform the functions required by the units included in the computing device of the embodiments in the present disclosure, or to execute the neural network computation method of the embodiments in the present disclosure.

The communication interface 503 uses a transceiving device such as, but not limited to, a transceiver to achieve communication between the computing device 500 and other devices or communication networks. For example, sign language information of a target passenger can be obtained through the communication interface 503.

The bus can include pathways for transmitting information between various components of the computing device 500 (e.g., the memory 502, the processor 501, and the communication interface 503).

It should be understood that the obtaining unit 401, the determining unit 402, the adjusting unit 403, and the computing unit 404 within the computing device can be equivalent to the processor 501.

It should be noted that although the computing device 500 shown in FIG. 5 only illustrates a memory, a processor, a display, and a communication interface, in the specific implementation process, a person skilled in this art should understand that the computing device 500 also includes other components necessary for normal operation. At the same time, depending on specific needs, those skilled in this art should understand that the computing device 500 may also include hardware components for achieving additional functions.

Furthermore, those skilled in this art should understand that the computing device 500 may only include the components necessary to implement the embodiments of the present disclosure, and there is no need to include all the components shown in FIG. 5.

Persons of ordinary skill in the art may realize that the units and algorithmic steps of the examples described in conjunction with the embodiments disclosed herein can be implemented in electronic hardware, or in a combination of computer software and electronic hardware. Whether these functions are performed in hardware or software depends on the specific application and design constraints of the technical solution. Technical professionals may use different methods for each particular application to achieve the described functions, but such implementation should not be considered beyond the scope of the present disclosure.

An embodiment of the present disclosure also provides a computer storage medium in which the computer storage medium may store a program which, when executed, may implement some or all of the steps including any of the neural network computation method described in the embodiments of the method. The storage medium may include a USB flash drive, an ROM, an RAM, a portable hard disk, a magnetic disk or an optical disc and other media that can store program codes.

In the present disclosure, the target input data arrangement type of the current operator is determined by judging whether the operator is a data-arrangement-sensitive operator or a data-arrangement-insensitive operator. Based on the first input data of the current operator and the target input data arrangement type, the first input data can be dynamically adjusted. The input of the operator is adjusted only when necessary, and the output of the operator is not adjusted. By dynamically adjusting the data arrangement type of the first input data, the data arrangement in the neural network computation is no longer fixed and uniform. Further, it can reduce unnecessary data arrangement conversion, especially it is not needed to convert the data arrangement type of the output data, and at most only the data arrangement type conversion is performed on the input data. This can reduce the number of data arrangement conversion, speed up the computation, and decrease memory overhead.

It should be noted that, for the purpose of simple description, each of the foregoing embodiments of the method is expressed as a series of combinations of actions, but those skilled in the art should be aware that the present disclosure is not limited by the sequence of actions described, as some steps may be performed in other sequences or simultaneously according to the present disclosure. Secondly, those skilled in the art should also know that the embodiments described in the specification are all preferred embodiments, and the actions and modules involved are not necessarily compulsory for this disclosure.

In the above embodiments, the description of each embodiment has its own emphasis. For a part that is not described in detail in one embodiment, reference may be made to related descriptions in other embodiments.

It should be understood that in the embodiments provided by the present disclosure, the disclosed device may be implemented in another manner. For instance, the embodiments above are merely illustrative. For instance, the division of the units is only a logical function division. In a real implementation, there may be another manner for division. For instance, a plurality of units or components may be combined or may be integrated in another system, or some features can be ignored or not performed. In addition, the displayed or discussed mutual coupling or direct coupling or communication connection may be implemented through indirect coupling or communication connection of some interfaces, devices or units, and may be electrical or in other forms.

The units described as separate components may or may not be physically separated. The components shown as units may or may not be physical units. In other words, the components may be located in one place, or may be distributed to a plurality of network units. According to certain needs, some or all of the units can be selected for realizing the purposes of the embodiments of the present disclosure.

The foregoing can be better understood in accordance with the following articles.
Article A1. A neural network computation method, including:
obtaining a piece of first input data of a current operator and a data arrangement type of the first input data;
determining a target input data arrangement type of the current operator;
adjusting the first input data according to the target input data arrangement type of the current operator to obtain a piece of second input data, where a data arrangement type of the second input data is the same as the target input data arrangement type of the current operator; and
computing based on the second input data and the current operator to obtain an output result, which is a piece of input data of a downstream operator of the current operator or a piece of output data of the neural network.
Article A2. The method of Article A1, determining the target input data arrangement type of the current operator includes:
determining the target input data arrangement type of the current operator according to data arrangement requirement of the current operator when the current operator is a data-arrangement-sensitive operator.
Article A3. The method of Article A1, determining the target input data arrangement type of the current operator includes:
determining the target input data arrangement type of the current operator according to the data arrangement type of the first input data when the current operator is a data-arrangement-insensitive operator.
Article A4. The method of Article A2, adjusting the first input data according to the target input data arrangement type of the current operator to obtain the second input data includes:
performing a data arrangement conversion on the first input data to obtain the second input data.
Article A5. The method of Article A3, adjusting the first input data according to the target input data arrangement type of the current operator to obtain the second input data includes:
determining the first input data as the second input data.
Article A6. The method of Article A4, before performing the data arrangement conversion on the first input data to obtain the second input data, further including:
determining whether the data arrangement type of the first input data is the same as the target input data arrangement type of the current operator;
performing the data arrangement conversion on the first input data to obtain the second input data when the data arrangement type of the first input data is different from the target input data arrangement type of the current operator; and
taking the first input data as the second input data when the data arrangement type of the first input data is the same as the target input data arrangement type of the current operator.
Article A7. The method of Article A3 or A5, where the first input data includes a plurality of pieces of input data, and the data arrangement type of the first input data includes a plurality of data arrangement types corresponding to the plurality of pieces of input data, where
determining the target input data arrangement type of the current operator includes:
arbitrarily selecting one of the data arrangement types corresponding to the plurality of pieces of input data as the target input data arrangement type of the current operator;
or
determining the target input data arrangement type of the current operator according to the plurality of data arrangement types corresponding to the plurality of pieces of input data and a plurality of memories occupied by the plurality of pieces of input data.
Article A8. The method of Article A7, determining the target input data arrangement type of the current operator according to the plurality of data arrangement types corresponding to the plurality of pieces of input data and the plurality of memories occupied by the plurality of pieces of input data includes:
accumulating memories occupied by input data with the same data arrangement type among the plurality of pieces of input data respectively; and
determining a data arrangement type corresponding to a maximum memory accumulation result as the target input data arrangement type of the current operator.
Article A9. The method of any one of Articles A2˜A8, the data-arrangement-sensitive operator includes at least one of following operators:
an operator that has an explicit requirement on a data arrangement type of input data;
an operator that has no explicit requirement on the data arrangement type of the input data, but the input data contains a mask, an index, and a tensor related to an arrangement order; and
an operator whose input data dimension is different from an output dimension, or an operator that depends on an adjacent relationship of dimensions.
Article A10. The method of any one of Articles A2˜A9, the data-arrangement-insensitive operator includes at least one of following operators:
an operator with the same computation logic for all input elements; and
an operator that operates on a specified dimension and has no dependency on the adjacent relationship of the dimensions, or an addition operator, a subtraction operator, a multiplication operator, or a division operator.
Article A11. A neural network computing device, including:
an obtaining unit configured to obtain a piece of first input data of a current operator and a data arrangement type of the first input data;
a determining unit configured to determine a target input data arrangement type of the current operator;
an adjusting unit configured to adjust the first input data according to the target input data arrangement type of the current operator to obtain a piece of second input data, where a data arrangement type of the second input data is the same as the target input data arrangement type of the current operator; and
a computing unit configured to compute based on the second input data and the current operator to obtain an output result, which is a piece of input data of a downstream operator of the current operator or a piece of output data of the neural network.
Article A12. The computing device of Article A11, where the determining unit is specifically configured to:
when the current operator is a data-arrangement-sensitive operator, determine the target input data arrangement type of the current operator according to data arrangement requirement of the current operator.
Article A13. The computing device of Article A11, where the determining unit is specifically configured to:
when the current operator is a data-arrangement-insensitive operator, determine the target input data arrangement type of the current operator according to the data arrangement type of the first input data.
Article A14. The computing device of Article A12, where the adjusting unit is specifically configured to:
perform a data arrangement conversion on the first input data to obtain the second input data.
Article A15. The computing device of Article A13, where the adjusting unit is specifically configured to:
determine the first input data as the second input data.
Article A16. The computing device of Article A14, where the determining unit is further configured to:
determine, before performing the data arrangement conversion on the first input data to obtain the second input data, whether the data arrangement type of the first input data is the same as the target input data arrangement type of the current operator;
perform the data arrangement conversion on the first input data to obtain the second input data when the data arrangement type of the first input data is different from the target input data arrangement type of the current operator; and
take the first input data as the second input data when the data arrangement type of the first input data is the same as the target input data arrangement type of the current operator.
Article A17. The computing device of Article A13 or A15, where the first input data includes a plurality of pieces of input data, and the data arrangement type of the first input data includes a plurality of data arrangement types corresponding to the plurality of pieces of input data, where
the determining unit is specifically configured to:
arbitrarily select one of the data arrangement types corresponding to the plurality of pieces of input data as the target input data arrangement type of the current operator;
or
determine the target input data arrangement type of the current operator according to the plurality of data arrangement types corresponding to the plurality of pieces of input data and a plurality of memories occupied by the plurality of pieces of input data.
Article A18. The computing device of Article A17, where in terms of determining the target input data arrangement type of the current operator according to the plurality of data arrangement types corresponding to the plurality of pieces of input data and a plurality of memories occupied by the plurality of pieces of input data, the determining unit is specifically configured to:
accumulate memories occupied by input data with the same data arrangement type among the plurality of pieces of input data respectively; and
determine a data arrangement type corresponding to a maximum memory accumulation result as the target input data arrangement type of the current operator.
Article A19. The computing device of any one of Articles A2˜A18, where the data-arrangement-sensitive operator includes at least one of following operators:
an operator that has an explicit requirement on a data arrangement type of input data;
an operator that has no explicit requirement on the data arrangement type of the input data, but the input data contains a mask, an index, and a tensor related to arrangement of the input data; and
an operator whose input data dimension is different from an output dimension, or an operator that depends on an adjacent relationship of dimensions.
Article A20. The computing device of any one of Articles A2˜A19, where he data-arrangement-insensitive operator includes at least one of following operators:
an operator with the same computation logic for all input elements;
an operator that operates on a specified dimension and has no dependency on the adjacent relationship of the dimensions, or an addition operator, a subtraction operator, a multiplication operator, or a division operator.
Article A21. An electronic device, including a processor and a memory, where the processor and the memory are connected, the memory is configured to store program codes, and the processor is configured to call the program codes to execute the method of any one of Articles A1˜A10.
Article A22. An artificial intelligence chip, applied to an electronic device, where the artificial intelligence chip includes one or more interface circuits and one or more processors; the interface circuit(s) and the processor(s) are interconnected by lines; the interface circuit(s) is configured to receive signals from a memory of the electronic device and send signals to the processor(s), and the signals include computer instructions stored in the memory; and when the processor executes the computer instructions, the electronic device executes the method of any one of Articles A1˜A10.
Article A23. A computer readable storage medium, in which a computer program is stored, where the computer program is executed by a processor to implement the method of any one of Articles A1˜A10.
Article A24. A computer program product, including computer instructions, where when the computer instructions are run on an electronic device, the electronic device is enabled to implement and execute the method of any one of Articles A1˜A10.

The above embodiments of the present disclosure are introduced in detail. In this disclosure, specific embodiments are applied to explain the principle and implementation of the present disclosure. The above embodiments are only used to help understand the method and core ideas of the present disclosure. At the same time, for persons of ordinary skill in the art, according to the idea of the present disclosure, there will be changes in the specific implementation and scope of application, in summary, the content of this specification should not be understood as a limitation of the present disclosure.

1. A neural network computation method, comprising:
obtaining a piece of first input data of a current operator and a data arrangement type of the first input data;
determining a target input data arrangement type of the current operator;
adjusting the first input data according to the target input data arrangement type of the current operator to obtain a piece of second input data, wherein a data arrangement type of the second input data is the same as the target input data arrangement type of the current operator; and
computing based on the second input data and the current operator to obtain an output result, which is a piece of input data of a downstream operator of the current operator or a piece of output data of the neural network.

2. The method of claim 1, determining the target input data arrangement type of the current operator comprises:
determining the target input data arrangement type of the current operator according to data arrangement requirement of the current operator when the current operator is a data-arrangement-sensitive operator; or
determining the target input data arrangement type of the current operator according to the data arrangement type of the first input data when the current operator is a data-arrangement-insensitive operator.

3. (canceled)

4. The method of claim 2, adjusting the first input data according to the target input data arrangement type of the current operator to obtain the second input data comprises:
performing a data arrangement conversion on the first input data to obtain the second input data; or
determining the first input data as the second input data.

5. (canceled)

6. The method of claim 4, before performing the data arrangement conversion on the first input data to obtain the second input data, further comprising:
determining whether the data arrangement type of the first input data is the same as the target input data arrangement type of the current operator;
performing the data arrangement conversion on the first input data to obtain the second input data when the data arrangement type of the first input data is different from the target input data arrangement type of the current operator; and
taking the first input data as the second input data when the data arrangement type of the first input data is the same as the target input data arrangement type of the current operator.

7. The method of claim 2, wherein the first input data comprises a plurality of pieces of input data, and the data arrangement type of the first input data comprises a plurality of data arrangement types corresponding to the plurality of pieces of input data, wherein
determining the target input data arrangement type of the current operator comprises:
arbitrarily selecting one of the data arrangement types corresponding to the plurality of pieces of input data as the target input data arrangement type of the current operator;
or
determining the target input data arrangement type of the current operator according to the plurality of data arrangement types corresponding to the plurality of pieces of input data and a plurality of memories occupied by the plurality of pieces of input data.

8. The method of claim 7, determining the target input data arrangement type of the current operator according to the plurality of data arrangement types corresponding to the plurality of pieces of input data and the plurality of memories occupied by the plurality of pieces of input data comprises:
accumulating memories occupied by input data with the same data arrangement type among the plurality of pieces of input data respectively; and
determining a data arrangement type corresponding to a maximum memory accumulation result as the target input data arrangement type of the current operator.

9. The method of claim 2, the data-arrangement-sensitive operator comprises at least one of following operators:
an operator that has an explicit requirement on a data arrangement type of input data;
an operator that has no explicit requirement on the data arrangement type of the input data, but the input data contains a mask, an index, and a tensor related to an arrangement order; and
an operator whose input data dimension is different from an output dimension, or an operator that depends on an adjacent relationship of dimensions.

10. The method of claim 2, the data-arrangement-insensitive operator comprises at least one of following operators:
an operator with the same computation logic for all input elements; and
an operator that operates on a specified dimension and has no dependency on the adjacent relationship of the dimensions, or an addition operator, a subtraction operator, a multiplication operator, or a division operator.

11. A neural network computing device, comprising:
an obtaining unit configured to obtain a piece of first input data of a current operator and a data arrangement type of the first input data;
a determining unit configured to determine a target input data arrangement type of the current operator;
an adjusting unit configured to adjust the first input data according to the target input data arrangement type of the current operator to obtain a piece of second input data, wherein a data arrangement type of the second input data is the same as the target input data arrangement type of the current operator; and
a computing unit configured to compute based on the second input data and the current operator to obtain an output result, which is a piece of input data of a downstream operator of the current operator or a piece of output data of the neural network.

12. The computing device of claim 11, wherein the determining unit is specifically configured to:
when the current operator is a data-arrangement-sensitive operator, determine the target input data arrangement type of the current operator according to data arrangement requirement of the current operator; or
when the current operator is a data-arrangement-insensitive operator, determine the target input data arrangement type of the current operator according to the data arrangement type of the first input data.

13. (canceled)

14. The computing device of claim 12, wherein the adjusting unit is specifically configured to:
perform a data arrangement conversion on the first input data to obtain the second input data; or
determine the first input data as the second input data.

15. (canceled)

16. The computing device of claim 14, wherein the determining unit is further configured to:
determine, before performing the data arrangement conversion on the first input data to obtain the second input data, whether the data arrangement type of the first input data is the same as the target input data arrangement type of the current operator;
perform the data arrangement conversion on the first input data to obtain the second input data when the data arrangement type of the first input data is different from the target input data arrangement type of the current operator; and
take the first input data as the second input data when the data arrangement type of the first input data is the same as the target input data arrangement type of the current operator.

17. The computing device of claim 12, wherein the first input data comprises a plurality of pieces of input data, and the data arrangement type of the first input data comprises a plurality of data arrangement types corresponding to the plurality of pieces of input data, wherein
the determining unit is specifically configured to:
arbitrarily select one of the data arrangement types corresponding to the plurality of pieces of input data as the target input data arrangement type of the current operator;
or
determine the target input data arrangement type of the current operator according to the plurality of data arrangement types corresponding to the plurality of pieces of input data and a plurality of memories occupied by the plurality of pieces of input data.

18. The computing device of claim 17, wherein in terms of determining the target input data arrangement type of the current operator according to the plurality of data arrangement types corresponding to the plurality of pieces of input data and a plurality of memories occupied by the plurality of pieces of input data, the determining unit is specifically configured to:
accumulate memories occupied by input data with the same data arrangement type among the plurality of pieces of input data respectively; and
determine a data arrangement type corresponding to a maximum memory accumulation result as the target input data arrangement type of the current operator.

19. The computing device of claim 12, wherein the data-arrangement-sensitive operator comprises at least one of following operators:
an operator that has an explicit requirement on a data arrangement type of input data;
an operator that has no explicit requirement on the data arrangement type of the input data, but the input data contains a mask, an index, and a tensor related to arrangement of the input data; and
an operator whose input data dimension is different from an output dimension, or an operator that depends on an adjacent relationship of dimensions.

20. The computing device of claim 12, wherein the data-arrangement-insensitive operator comprises at least one of following operators:
an operator with the same computation logic for all input elements;
an operator that operates on a specified dimension and has no dependency on the adjacent relationship of the dimensions, or an addition operator, a subtraction operator, a multiplication operator, or a division operator.

21-24. (canceled)
